(19) United States
(12) Patent Application Publication
(10) Pub. No.: US 2025/0249440 A1
(43) Pub. Date: Aug. 7, 2025

(54) PROCESS AND CATALYST FOR CATALYTIC CRACKING OF NAPHTHA TO LIGHT OLEFINS AND AROMATICS

(71) Applicant: Hindustan Petroleum Corporation Limited, Bengaluru (IN)

(72) Inventors: Bhanuprasad Saiyapaneni Gopinath, Bengaluru (IN); Kumaresan Loganathan, Bengaluru (IN); Pramod Kumar, Bengaluru (IN); Narendra Karri, Bengaluru (IN); Sriram Sundaram, Bengaluru (IN); Vipul Kumar Maheshwari, Bengaluru (IN)

(21) Appl. No.: 19/042,753

(22) Filed: Jan. 31, 2025

(30) Foreign Application Priority Data
Feb. 1, 2024 (IN) 202441006781

(51) Int. Cl. B01J 29/46; B01J 35/40; B01J 35/51; B01J 35/61; B01J 35/63; B01J 35/64; B01J 37/04; B01J 37/12; C10G 11/18

(52) U.S. Cl. CPC B01J 29/46; B01J 35/40; B01J 35/51; B01J 35/615; B01J 35/638; B01J 35/647; B01J 37/04; B01J 37/12; C10G 11/182; C10G 2300/1044; C10G 2300/706; C10G 2400/20; C10G 2400/30

(57) ABSTRACT

The present invention pertains to a catalytic cracking. More specifically, the present invention pertains to a process for the preparation of a catalyst for cracking a hydrocarbon stream wherein the catalyst comprises a modified zeolite and a modified alumina. The present invention further provides a process and an apparatus for the cracking of a hydrocarbon stream into higher yield of lighter olefins and aromatics by employing the catalyst while sustaining the unit heat balance. The catalyst of the present invention shows enhanced coke formation, higher propylene to ethylene weight ratio and a higher BTX selectivity when used in the cracking of hydrocarbon stream.

### CROSS REFERENCE TO RELATED APPLICATION

This application claims priority to Indian Application No. 2024411006781, filed Feb. 1, 2024, which is hereby incorporated by reference in its entirety.

### FIELD OF THE INVENTION

The present invention pertains to a catalytic cracking. More specifically, the present invention pertains to a process for the preparation of a catalyst for cracking of a hydrocarbon stream. The present invention also provides a process and an apparatus for the cracking of a hydrocarbon stream comprising a hydrocarbon stream comprising a naphtha feed by employing the catalyst into higher yield of lighter olefins and aromatics while sustaining the unit heat balance.

### BACKGROUND OF THE INVENTION

In this era, achieving net-zero carbon emissions is mainly focused; hence the pursuit of environmentally friendly chemical processes has received unprecedented attention. The demand and production of light olefins are much higher than the demand and production of other chemical products, as the light olefins are essential organic chemical feedstocks and play a crucial role in chemical systems worldwide. The light olefins have been produced mainly by the steam cracking process for over half a century. Gasoline, ethylene, and diesel are the main products of the steam cracking process, and propylene is primarily produced as a byproduct. However, the steam cracking process suffers from high energy consumption due to high reaction temperatures (>800° C.) and low light olefin (ethylene and propylene) selectivity, and the distribution of light olefins is difficult to adjust. The progress of naphtha catalytic pyrolysis to produce ethylene and propylene has attracted increasing attention from petrochemical industrial due to practical and economic consideration, low reaction temperature (600-700° C.), and high light olefin selectivity because catalytic cracking process reduces the energy consumption and carbon dioxide emission, increases the yields of light olefins and adjusts the distribution of the product.

The catalytic process plays a decisive role, and the catalyst is the crucial factor in the catalytic cracking reaction. Currently, solid acid catalysts that include zeolites, metals supported on zeolites (such as ZSM-5, ZSM-22, MOR, ZSM-48, SAPO34, MCM-22 etc.), and mixed metal-zeolite have been extensively used to enhance the yield of light olefins in the catalytic cracking of naphtha. Because of the characteristics of strong acidity, hydrothermal stability, and low hydrogen transfer activity of zeolite, the special pore structure demonstrates the advantage of shape selectivity in the catalytic cracking of naphtha.

U.S. Pat. No. 10,633,597 by IFP Energies nouvelles discloses a process for the catalytic cracking of a gasoline feedstock for the production of light olefins, in which said gasoline feedstock is brought into contact with a catalyst comprising at least one zeolite NU-86, alone or in a mixture with at least one other zeolite, at a temperature comprised between 50° and 700° C., at an absolute pressure comprised between 10 and 60 MPa, and with a contact time of the feedstock on said catalyst comprised between 10 milliseconds and 100 seconds.

US 2020/0087228 by Gasolfin discloses a process to prepare propylene from a hydrocarbon feed comprising pentane by contacting the hydrocarbon feed with a heterogeneous cracking catalyst as present in one or more fixed beds thereby obtaining a cracked effluent. The heterogeneous catalyst comprises a matrix component and a molecular sieve comprising framework alumina, framework silica and a framework metal selected from the group of Zn, Fe, Ce, La, Y, Ga and/or Zr. Propylene is isolated from cracked effluent.

U.S. Pat. No. 11,274,257 by IOCL discloses a process for a production of light olefins and aromatics from cracked light naphtha by selective cracking. This process is based on catalytic cracking in which the catalyst activity is optimized by depositing coke for production of light olefins and aromatics. The proposed process has high flexibility and can be operated either in maximizing olefins as reflected from the PIE ratio or in maximizing aromatics (BTX) at different modes of operation depending upon the product requirement. The mixed olefinic cracked naphtha is catalytically cracked in moving bed reactor by contacting with a zeolite catalyst for a residence time ranging between 35-65 minutes and at a pressure ranging between 1-2 bar to obtain cracked product comprising light olefins in the range of 30-50 wt. % and obtaining the light olefins as a gaseous product with a propylene to ethylene ratio (P/E) in the range of 1-5.

EP 2 049 622 by KBR described a dual riser FCC process cracking comprising a first hydrocarbon feed having a carbon number less than 12 in a first riser under first-riser FCC conditions, thereby forming a first effluent enriched in ethylene, propylene or a combination thereof; cracking a second hydrocarbon feed having a carbon number less than 12 in a second riser under second-riser FCC conditions, thereby forming a second effluent enriched in ethylene, propylene or a combination thereof, wherein the first and second hydrocarbon feeds are different and the first-riser and second-riser FCC conditions are independently selected to favor production of ethylene, propylene or a combination thereof.

U.S. Pat. No. 8,685,232 by RIL Manufacture of propylene and ethylene in a FCC unit. Each FCC riser comprises an acceleration Zone, a lift stream feed nozzle, a main hydrocarbon Stock feed nozzle, and an olefinic naphtha feed nozzle. Mixed FCC catalyst comprising at least 2 percent by weight pentasil Zeolite and at least 10 percent by weight Y-Zeolite is injected at the bottom of each FCC riser. Olefinic naphtha is injected through the olefinic feed nozzle, main hydrocarbon stock is injected through the main hydrocarbon stock feed nozzle and lift stream is injected through the lift stream feed nozzle. Lift stream comprises olefinic hydrocarbon stream and optionally steam and/or a fuel gas. Olefinic hydrocarbon Steam is cracked in the acceleration Zone at 600 to 800° C., 0.8 to 5 kg/cm (gauge) pressure, WHSV 0.2 to 100 hr up 1 and vapour residence time 0.2 to 5 seconds.

U.S. Pat. No. 7,601,663 by SK Energy Co., Ltd describes a porous solid acid catalyst for producing light olefins is prepared through pillaring and a solid state reaction of a raw material mixture. The catalyst is made of a porous material having a crystalline structure that is different from that of the raw material mixture. The catalyst exhibits excellent catalytic activity (i.e., conversion and selectivity) in the production of light olefins from hydrocarbon feeds such as full range naphtha.

Many prior arts disclose the catalyst composition of having ZSM-5 as active zeolites along with metal incorporated in framework to enhance the stability and selectivity of the products. However, the catalyst disclosed in the prior art didn't address the coke selectivity during fluidization process without compromising yields and selectivity.

Therefore, there is a need of a catalyst and process for preparation of such a catalyst for the catalytic cracking that can address the coke selectivity during fluidization process without compromising yields and selectivity. Further, there is a requirement of an apparatus for the efficient catalytic cracking.

### OBJECTIVES OF THE INVENTION

The main objective of the present invention is to provide a catalyst for cracking of hydrocarbon.

Another objective of the present invention is to provide a process for the synthesis of the catalyst.

Another objective of the present invention is to utilize the catalyst in catalytic cracking of naphtha to light olefins and aromatics.

Another objective of the present invention is to provide an apparatus for catalytic cracking of naphtha to light olefins and aromatics.

### SUMMARY OF THE INVENTION

This summary is provided to introduce a selection of concepts, in a simplified format, that are further described in the detailed description of the invention. This summary is neither intended to identify key or essential inventive concepts of the invention and nor is it intended to determine the scope of the invention.

The present invention provides a process for the preparation of a catalyst for catalytic cracking, said process comprises:
i. mixing ortho-phosphoric acid, hydrous kaolin clay, ammonia stabilized colloidal silica and a modified alumina to form a slurry and followed by milling the slurry to form a milled slurry;
ii. mixing a modified ZSM-5 zeolite in water to form a modified zeolite slurry;
iii. mixing the milled slurry with the modified zeolite slurry to obtain a final slurry;
iv. spray drying the final slurry to obtain a spray dried catalyst; and
v. calcining the spray dried catalyst to obtain the catalyst.

The present invention also provides a catalyst for the cracking of hydrocarbon stream, said catalyst comprises:
i. a modified ZSM-5 zeolite in a range of 40 to 60 weight % of the catalyst; wherein the modified ZSM-5 zeolite has a matrix framework structure and a surface; and
ii. a modified alumina in a range of 1 to 20 weight % of the catalyst;
   wherein the modified ZSM-5 zeolite comprises a ZSM-5 zeolite having a SiO₂/Al₂O₃ ratio of 30, the modified ZSM-5 zeolite has embedded in the matrix framework structure with a phosphate of metal selected from zinc, iron, gallium, cobalt, manganese and combination thereof; wherein the modified alumina is only in contact with the surface of the modified ZSM-5 zeolite.

The present invention also provides a process for the cracking of hydrocarbon employing the catalyst as obtained by the process as defined above or the catalyst as defined above, said process comprises:
i. contacting the hydrocarbon stream comprising a fresh naphtha feed (1) and a recycle liquid product stream (2) with the catalyst and optionally with steam (3) in a riser (4) to obtain a cracked effluent comprising gaseous products, liquid products, water and a spent catalyst;
ii. separating the spent catalyst from cracked effluent in a gas solid separation system (5) comprising cyclone separator (6) housed in a reactor (7) to obtain a reactor effluent (8), and sending the reactor effluent (8) to a gas-liquid separation section (9) for separating a gaseous product stream (10) comprising a C1-C4 hydrocarbon from a liquid product stream (11) comprising Benzene, Toluene, and Xylene (BTX);
iii. sending the spent catalyst to a stripper (12) having an inlet for feeding a stripping stream (13) to remove strippable hydrocarbons from the spent catalyst;
iv. passing the gaseous product stream (10) to a gas separator unit (14) to remove a hydrogen and methane enriched stream (15) from the gaseous product stream (10) for generating an enhanced gas stream (16) comprising an increased concentration of C2-C4 hydrocarbons for separation of lighter olefins comprising ethylene, propylene and butene from the C2-C4 hydrocarbons comprising ethane, propane, and butane;
v. extracting BTX (17) from the liquid product stream (11) in a separation column (18) to obtain a recycle liquid product stream (2), and sending the recycle liquid product stream (2) devoid of BTX (17) to the riser (4) for cracking and extinction;
vi. partially drawing the spent catalyst from the stripper (12) to a coke concentrator (19) wherein the spent catalyst is contacted with an external heavy feed (20) to obtain a cracked product and coke; the coke gets deposited on the spent catalyst to obtain a coke enriched spent catalyst;
vii. routing the cracked product from coke concentrator to the reactor (7) through a means (22); and
viii. sending the coke enriched spent catalyst from the coke concentrator through a means (21) as well as the spent catalyst directly from the stripper through a means (23) to a regenerator (24) wherein the coke deposited on the spent catalyst burns with oxygen containing gases comprises air (25) to obtain a flue gas (26) and a regenerated catalyst;
ix. circulating the regenerated catalyst from the regenerator (24) through a means (27) to the riser (4) for cracking of the hydrocarbon stream comprising fresh naphtha feed (1) and recycle liquid product stream (2).

The present invention further provides a system for the cracking of hydrocarbon comprising:
i. a riser (4) for cracking a hydrocarbon stream (1) comprising naphtha feed and recycle liquid product stream (2) in presence of a catalyst and optionally with steam (3) to obtain a cracked effluent comprising gaseous products, liquid products, water and a spent catalyst;
ii. a gas-solid separation system (5) comprising a cyclone separator (6) housed in a reactor (7) for separating the spent catalyst from the cracked effluent;
iii. a gas-liquid separation section (9) for separating a gaseous product stream (10) comprising a C1-C4 hydrocarbon and a liquid product stream (11) comprising Benzene, Toluene, and Xylene (BTX) (17); wherein BTX (17) is extracted from the liquid product stream (11);
iv. a separation column (18) to obtain a recycle liquid product stream (2) after separation of BTX components (17) is recycled to the riser (4);
v. a stripper (12) having an inlet for feeding a stripping stream (13) to remove strippable hydrocarbons from the spent catalyst;
vi. a gas separator unit (14) to remove hydrogen and methane enriched stream (15) from the gaseous product stream (10) for generating an enhanced gas stream (16) comprising an increased concentration of C2-C4 hydrocarbons for separation of lighter olefins comprising ethylene, propylene and butene from the C2-C4 hydrocarbons comprising ethane, propane, and butane;
vii. a coke concentrator (19) in stream communication with the stripper (12) for partially drawing the spent catalyst from the stripper (12); wherein the spent catalyst is contacted with an external heavy feed (20) to obtain a cracked product and coke; the cracked product is routed to the riser (4); and the coke gets deposited on the spent catalyst to obtain a coke enriched spent catalyst;
viii. a regenerator (24) to receive the coke enriched spent catalyst through a means (21) from coke concentrator (19) as well as the spent catalyst directly from the stripper (12) through a means (23) for burning the coke deposited on the spent catalyst with oxygen containing gases comprising air (25) to obtain a flue gas (26) and a regenerated catalyst; the regenerated catalyst from the regenerator (24) is circulated to the riser (4) through a means (27) for cracking of the hydrocarbon stream (1) and recycle liquid product stream (2).

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts the diagram of process steps for catalytic cracking of naphtha to light olefins and aromatics.

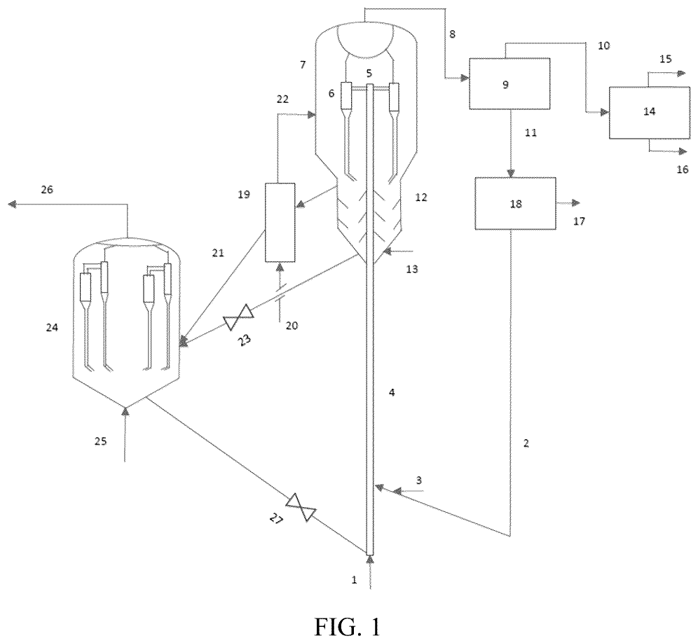

### DETAILED DESCRIPTION OF THE INVENTION

The present invention discloses a process for the preparation of a catalyst for cracking of a hydrocarbon stream. The catalyst comprising a modified ZSM-5 zeolite and a modified alumina is utilized in the cracking of a hydrocarbon stream to enhance the coke yield and thus aids in achieving the unit heat balance. The present invention further discloses a process for producing higher yield of light olefins with better flexibility of propylene/ethylene ratio and with higher BTX selectivity.

For the purpose of promoting an understanding of the principles of the invention, reference will now be made to the embodiments in the specific language to describe the same. It will nevertheless be understood that no limitation of the scope of the invention is thereby intended, such alterations and further modifications in the illustrated process, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The composition, methods, and examples provided herein are illustrative only and not intended to be limiting.

The articles “a”, “an” and “the” are used to refer to one or to more than one (i.e., to at least one) of the grammatical object of the article.

The term “some” as used herein is defined as “none, or one, or more than one, or all”. Accordingly, the terms “none”, “one”, “more than one”, “more than one, but not all” or “all” would all fall under the definition of “some”. The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments”.

More specifically, any terms used herein such as but not limited to “includes”, “comprises”, “has”, “consists” and grammatical variants thereof is inclusive or open-ended and does not exclude additional, unrecited elements or method steps. The specification will be understood to also include embodiments which have the transitional phrase “consisting of” or “consisting essentially of” in place of the transitional phrase “comprising”. The transitional phrase “consisting of” excludes any element, step, or ingredient not specified in the claim, except for impurities associated therewith. The transitional phrase “consisting essentially of” limits the scope of a claim to the specified materials or steps “and those that do not materially affect the basic and novel characteristic(s)” of the claimed invention.

Whether or not a certain feature or element was limited to being used only once, either way it may still be referred to as “one or more features” or “one or more elements” or “at least one feature” or “at least one element”. Furthermore, the use of the terms “one or more” or “at least one” feature or element do NOT preclude there being none of that feature or element, unless otherwise specified by limiting language such as “there NEEDS to be one or more” or “one or more element is REQUIRED”.

Use of the phrases and/or terms such as but not limited to “a first embodiment”, “a further embodiment”, “an alternate embodiment”, “one embodiment”, “an embodiment”, “multiple embodiments”, “some embodiments”, “other embodiments”, “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

The terminology and structure employed herein is for describing, teaching, and illuminating some embodiments and their specific features and elements and does not limit, restrict, or reduce the spirit and scope of the invention.

The present invention provides a process for the preparation of a catalyst for catalytic cracking, said process comprises:
i. mixing ortho-phosphoric acid, hydrous kaolin clay, ammonia stabilized colloidal silica and a modified alumina to form a slurry and followed by milling the slurry to form a milled slurry;
ii. mixing a modified ZSM-5 zeolite in water to form a modified zeolite slurry;
iii. mixing the milled slurry with the modified zeolite slurry to obtain a final slurry;
iv. spray drying the final slurry to obtain a spray dried catalyst; and
v. calcining the spray dried catalyst to obtain the catalyst.

In an embodiment the present invention provides the modified ZSM-5 zeolite is prepared by a process comprising:
i. mixing a ZSM-5 zeolite with 12 to 20 weight % of a metal monohydrate phosphate to form a zeolite mixture;
ii. adding water to the zeolite mixture to form a zeolite slurry;
iii. heating the zeolite slurry while mixing;
iv. filtering and washing the zeolite slurry to obtain a wet cake;
v. drying the wet cake; and
vi. calcining the wet cake to obtain the modified ZSM-5.

In an embodiment of the present invention, the ZSM-5 zeolite has a SiO₂/Al₂O₃ ratio of 30; the metal monohydrogen phosphate has a phosphate ion loading concentration of 8 to 20 weight % and a metal oxide in a range of 1 to 5 weight %.

In an embodiment of the present invention, the zeolite slurry is heated at a temperature in a range of 70° C. to 80° C. for 3 to 5 hours; the wet cake is dried at a temperature in a range of 120° C. to 150° C. for 10 to 18 hours and calcined at a temperature in a range of 700 to 750° C. for 3 to 5 hours.

In an embodiment the present invention provides the metal monohydrogen phosphate is prepared by a process comprises:
i. mixing a metal precursor in water and adding orthophosphoric acid in a mol ratio of 1:1 to form a solution;
ii. adding an ammonia solution to the solution to reach pH above 10;
iii. separating a precipitate through filtering;
iv. washing the precipitate to obtain a washed product; and
v. drying the washed product to obtain the metal monohydrogen phosphate.

In an embodiment of the present invention, the metal monohydrogen phosphate is selected from a group comprising zinc monohydrogen phosphate, iron monohydrogen phosphate, gallium monohydrogen phosphate, cobalt monohydrogen phosphate, and manganese monohydrogen phosphate.

In an embodiment of the present invention, the metal precursor is selected from a group zinc nitrate hexahydrate, gallium nitrate hydrate, iron nitrate hexahydrate, cobalt nitrate hexahydrate and manganese nitrate hexahydrate.

In an embodiment of the present invention, the ammonia solution is added into the solution to reach the pH in the range of 9 to 10; the precipitate is washed with water at a temperature in a range of 70 to 80° C. to bring the pH in the range of 6 to 7; the washed product is dried at a temperature in a range of 120° C. to 150° C. for 5 to 10 hours.

In an embodiment the present invention provides the modified alumina is prepared by mixing alumina with nickel nitrate hexahydrate in water to form a mixture; followed by drying the mixture to obtain a dried product; and calcining the dried product to obtain the modified alumina.

In an embodiment of the present invention, the milled slurry is mixed with modified zeolite slurry for 2 to 5 hours to make the final slurry; the final slurry is spray dried in a co-current spray drying unit having an inlet temperature of 370° C. to 450° C. and an outlet temperature of 170° C. to 200° C. to obtain the spray dried catalyst; the spray dried catalyst is calcined at a temperature in a range of 550° C. to 600° C. for 4 to 6 hours; wherein the catalyst is formed in a spherical microsphere shape.

The present invention also provides a catalyst for the cracking of hydrocarbon stream, said catalyst comprises:
i. a modified ZSM-5 zeolite in a range of 40 to 60 weight % of the catalyst; wherein the modified ZSM-5 zeolite has a matrix framework structure and a surface;
ii. a modified alumina in a range of 1 to 20 weight % of the catalyst;
   wherein the modified ZSM-5 comprises a ZSM-5 zeolite having a SiO₂/Al₂O₃ ratio of 30, the modified ZSM-5 zeolite has embedded in the matrix framework structure with a phosphate of metal selected from zinc, iron, gallium, cobalt, manganese and combination thereof; wherein the modified alumina is only in contact with the surface of the modified ZSM-5 zeolite.

In an embodiment, the catalyst has the modified ZSM-5 zeolite, which is obtained by the process as described above. The catalyst has the modified alumina, which is obtained by the process as described above.

In an embodiment of the present invention, the catalyst has a chemical composition comprises:
i. SiO₂ in 50 to 60 weight % of the catalyst;
ii. Al₂O₃ in 30 to 40 weight % of the catalyst;
iii. P₂O₅ in 6 to 12 weight % of the catalyst;
iv. NiO in 1 to 3 weight % of the catalyst and
v. and a metal oxide selected from a group comprising ZnO, Fe₂O₃, Ga₂O₃, Co₂O₃, and MnO₂ and combination thereof.

In an embodiment of the present invention, the modified alumina is acting as a coke enhancer and is only in contact with the surface of the ZSM-5 zeolite without destructing active sites of zeolites. The metal oxide selected from a group comprising ZnO, Fe₂O₃, Ga₂O₃, Co₂O₃, and MnO₂ are acting as activity enhancers in the catalyst.

In an embodiment of the present invention, the ZnO is in a range of 1 to 2.5 weight % of the catalyst; the Fe₂O₃ is in a range of 0.18 to 2.54 weight % of the catalyst; the Ga₂O₃ is 0.5 to 1.98 weight % of the catalyst; the Co₂O₃ is in a range of 0.01 to 2.08 weight % of the catalyst; the MnO₂ is 0.5 to 1.99 weight % of the catalyst.

In an embodiment of the present invention, the catalyst is a spherical microsphere having a surface area in a range of 160 to 180 m²/g; has a pore volume in a range of 0.3 to 0.34 m³/g; has a pore size in a range of 48 to 55 Å; has an ABD in a range of 0.90 to 0.93 g/cc; has an attrition index in a range of 2.6 to 3.4%; has an average particle size in a range of 78 to 85 micron; and has a total acidity of 760 to 890 mmol/g.

In an embodiment of the present invention the catalyst is obtained from the process for the preparation of catalyst as defined above.

The present invention also provides a process for the cracking of hydrocarbon employing the catalyst as obtained by the process as defined above or the catalyst as defined above, said process comprises:
i. contacting the hydrocarbon stream comprising a fresh naphtha feed (1) and a recycle liquid product stream (2) with the catalyst and optionally with steam (3) in a riser (4) to obtain a cracked effluent comprising gaseous products, liquid products, water and a spent catalyst;
ii. separating the spent catalyst from cracked effluent in a gas solid separation system (5) comprising cyclone separator (6) housed in a reactor (7) to obtain a reactor effluent (8), and sending the reactor effluent (8) to a gas-liquid separation section (9) for separating a gaseous product stream (10) comprising a C1-C4 hydrocarbon from a liquid product stream (11) comprising Benzene, Toluene, and Xylene (BTX);
iii. sending the spent catalyst to a stripper (12) having an inlet for feeding a stripping stream (13) to remove strippable hydrocarbons from the spent catalyst;
iv. passing the gaseous product stream (10) to a gas separator unit (14) to remove a hydrogen and methane enriched stream (15) from the gaseous product stream (10) for generating an enhanced gas stream (16) comprising an increased concentration of C2-C4 hydrocarbons for separation of lighter olefins comprising ethylene, propylene and butene from the C2-C4 hydrocarbons comprising ethane, propane, and butane;
v. extracting a BTX component (17) from the liquid product stream (11) in a separation column (18) to obtain a recycle liquid product stream (2), and sending the recycle liquid product stream (2) devoid of the BTX component (17) to the riser (4) for cracking and extinction;
vi. partially drawing the spent catalyst from the stripper (12) to a coke concentrator (19) wherein the spent catalyst is contacted with an external heavy feed (20) to obtain a cracked product and coke; the coke gets deposited on the spent catalyst to obtain a coke enriched spent catalyst;
vii. routing the cracked product from coke concentrator to the reactor (7) through a means (22); and
viii. sending the coke enriched spent catalyst from the coke concentrator through a means (21) as well as the spent catalyst directly from the stripper through a means (23) to a regenerator (24) wherein the coke deposited on the spent catalyst burns with oxygen containing gases comprises air (25) to obtain a flue gas (26) and a regenerated catalyst;
ix. circulating the regenerated catalyst from the regenerator (24) through a means (27) to the riser (4) for cracking of the hydrocarbon stream comprising fresh naphtha feed (1) and recycle liquid product stream (2).

In an embodiment of the present invention, the naphtha feed is derived from natural gas condensates of petroleum/oil wells, virgin or straight run naphtha streams from Crude Distillation Units as well as cracked naphtha streams from Fluid Catalytic Cracking, Delayed Coking and Visbreaking Units of Petroleum Refineries. The straight run and cracked naphtha streams can be whole boiling range or distinct cut streams such as light, medium and heavy cuts.

In an embodiment of the present invention, the naphtha feed comprises a sulfur content of in a range of 10 to 500 ppm, a density of 0.65 to 0.75 g/ml, and a boiling point of 30 to 210° C.

In an embodiment of the present invention, the hydrocarbon stream in the fluidized bed reactor is contacted with the catalyst at a catalyst to oil ratio of 18 to 25; the stream to hydrocarbon ratio of 10 to 50 (weight/weight), at a temperature in a range of 600 to 700° C.

In an embodiment of the present invention, the catalyst is having higher light olefin and coke yield making propensity and in presence of hydrocarbon steam to form valuable petrochemical feedstocks such as ethylene, propylene and butenes as well as BTX.

In an embodiment of the present invention, the catalyst when used in cracking of a light straight run naphtha, the obtained product stream has a propylene to ethylene a weight ratio of 1.72, a BTX selectivity of 59.83 weight % and coke content of 2.0 weight %.

In an embodiment of the present invention, the catalyst when used in cracking of a full range straight run naphtha, the obtained product stream has a propylene to ethylene a weight ratio of 1.54, a BTX selectivity of 40.78 weight % and coke content of 2.3 weight %.

In an embodiment of the present invention, the heat balance of the process is mostly met by the functionality of the catalyst in making more coke in-situ during catalytic cracking of the lighter hydrocarbon streams such as naphtha. Heat balance is fully satisfied by either preheating of the feed or by processing of coke precursors such as recycle heavy hydrocarbon streams generated in the cracking process optionally with processing of external heavy hydrocarbon streams (boiling point range: 370° C. and above) in a separate vessel serving the purpose as a coke concentrator located in stream communication to spent catalyst transfer line from stripper to regenerator.

The present invention further provides a system for the cracking of hydrocarbon comprising:
i. a riser (4) for cracking a hydrocarbon stream (1) comprising naphtha feed and recycle liquid product stream (2) in presence of a catalyst and optionally with steam (3) to obtain a cracked effluent comprising gaseous products, liquid products, water and a spent catalyst;
ii. a gas-solid separation system (5) comprising a cyclone separator (6) housed in a reactor (7) for separating the spent catalyst from the cracked effluent;
iii. a gas-liquid separation section (9) for separating a gaseous product stream (10) comprising a C1-C4 hydrocarbon and a liquid product stream (11) comprising Benzene, Toluene, and Xylene (BTX) (17); wherein BTX (17) is extracted from the liquid product stream (11);
iv. a separation column (18) to obtain a recycle liquid product stream (2) after separation of BTX (17) is recycled to the riser (4);
v. a stripper (12) having an inlet for feeding a stripping stream (13) to remove strippable hydrocarbons from the spent catalyst;
vi. a gas separator unit (14) to remove hydrogen and methane enriched stream (15) from the gaseous product stream (10) for generating an enhanced gas stream (16) comprising an increased concentration of C2-C4 hydrocarbons for separation of lighter olefins comprising ethylene, propylene and butene from the C2-C4 hydrocarbons comprising ethane, propane, and butane;
vii. a coke concentrator (19) in stream communication with the stripper (12) for partially drawing the spent catalyst from the stripper (12); wherein the spent catalyst is contacted with an external heavy feed (20) to obtain a cracked product and coke; the cracked product is routed to the riser (4); and the coke gets deposited on the spent catalyst to obtain a coke enriched spent catalyst;
viii. a regenerator (24) to receive the coke enriched spent catalyst through a means (21) from coke concentrator (19) as well as the spent catalyst directly from the stripper (12) through a means (23) for burning the coke deposited on the spent catalyst with oxygen containing gases comprising air (25) to obtain a flue gas (26) and a regenerated catalyst; the regenerated catalyst from the regenerator (24) is circulated to the riser (4) through a means (27) for cracking of the hydrocarbon stream (1) and recycle liquid product stream (2).

### EXAMPLES

The present disclosure with reference to the accompanying examples describes the present invention. However, those of skill in the art should, in light of the present disclosure, appreciate that many changes can be made in the specific embodiments which are disclosed and still obtain a like or similar result without departing from the spirit and scope of the invention. It is understood that the examples are provided for the purpose of illustrating the invention only and are not intended to limit the scope of the invention in any way.

### Example 1: Preparation of Metal Phosphate

297 g of zinc nitrate was dissolved in 800 g demineralized (DM) water. 196 g of 50% ortho phosphoric acid was added to the dissolved solution and continue the stirring to form solution-1. 300 g of 25% of ammonia solution was added dropwise into solution-1 to reach the pH above 10. The white precipitate was filtered and washed with DM water of 70 to 80° C. to bring the pH less than 7. The washed product was dried at 120° C. for 5 h to obtain zinc monohydrogen phosphate. Similarly iron monohydrogen phosphate, gallium monohydrogen phosphate, cobalt monohydrogen phosphate, manganese monohydrogen phosphate were prepared as stabilizing agents for zeolites.

### Modification of Zeolites

### Example-2: Modification of Zsm-5 Zeolite with Zinc Monohydrogen Phosphate

500 g of ZSM-5 zeolite with SiO₂/Al₂O₃ ratio 30 was mixed with above 155 g of zinc monohydrogen phosphate having phosphate ion loading concentration of 12 wt. % and zinc oxide of 4.5%, 5000 g of DM water was added to the prepared zeolite mixer to get a zeolite slurry. The zeolite slurry was mixed and heated at 70° C. for 3 hours. After 3 hours, zeolite slurry was filtered and washed with DM water for 2 times to obtain wet cake. The wet cake was dried at 120° C. for 10 hours and calcined at 750° C. for 3 hours. Similarly, ZSM-5 zeolite was treated with other metal monohydrogen phosphates in the examples and calcined at 700° C. for 3 hours.

### Example 3: Modification of Zsm-5 Zeolite with Iron Monohydrogen Phosphate

This example is as per example 2 and the metal monohydrogen phosphate used in this example is iron monohydrogen phosphate.

### Example 4: Modification of Zsm-5 Zeolite with Gallium Monohydrogen Phosphate

This example is as per example 2 and the metal monohydrogen phosphate used in this example is gallium monohydrogen phosphate.

### Example 5: Modification of Zsm-5 Zeolite with Cobalt Monohydrogen Phosphate

This example is as per example 2 and the metal monohydrogen phosphate used in this example is cobalt monohydrogen phosphate.

### Example 6: Modification of Zsm-5 Zeolite with Manganese Monohydrogen Phosphate

This example is as per example 2 and the metal monohydrogen phosphate used in this example is manganese monohydrogen phosphate.

### Example 7: Modification of Alumina Matrix

146 g of alumina with loss on ignition of 33% is mixed with 7.8 g of nickel nitrate hexahydrate and 40 g of DM water. The mixture was mixed for 30 min and kept for drying at 120° C. for 5 h. The dried product was calcined at 550° C. for 2 h.

### Example 8: Preparation of Catalyst for the Present Invention

3 g of ortho-phosphoric acid, 190 g of hydrous kaolin clay, 150 g of ammonia stabilized colloidal silica and 29 g of modified alumina from example-7 were mixed to form uniform slurry and milled at 3D wet ball for 5 hours. 190 g of modified ZSM-5 from example 2 is mixed with 300 g of DM water to form uniformed zeolite slurry. The milled slurry was mixed with zeolites slurry for 2 h to make final slurry. The slurry was spray dried in a spray drying unit having an inlet temperature of 450° C. and outlet temperature of 170° C. to form spherical microsphere in a co-current spray dryer unit. The spray dried catalyst was calcined at 550° C. for 4 hours to form final NTO catalyst. The physico-chemical properties of the catalyst are mentioned in Table 1.

### Example 9

Example 9 is NTO catalyst, prepared from iron modified ZSM-5 zeolite with milled clay-alumina slurry as per example 8. The physico-chemical properties of the catalyst is mentioned in Table 1.

### Example 10

Example 10 is NTO catalyst, prepared from gallium modified ZSM-5 zeolite with milled clay-alumina slurry as per example 8. The physico-chemical properties of the catalyst are mentioned in Table 1.

### Example 11

Example 11 is NTO catalyst, prepared from cobalt modified ZSM-5 with milled clay-alumina slurry as per example 8. The physico-chemical properties of the catalyst are mentioned in Table 1.

### Example 12

Example 12 is NTO catalyst, prepared from manganese modified ZSM-5 with milled clay alumina slurry as per example 8. The physico-chemical properties of the catalyst are mentioned in Table 1.

### Example 13 (Comparative Example)

3 g of ortho-phosphoric acid, 190 g of hydrous kaolin clay, 150 g of ammonia stabilized colloidal silica and 29 g of alumina without modification were mixed to form uniform slurry and milled at 3D wet ball for 5 hours. 190 g of modified ZSM-5 from Example 2 is mixed with 300 g of DM water to form uniformed zeolite slurry. The milled slurry was mixed with zeolites slurry for 2 h to make final slurry. The slurry was spray dried at inlet temperature of 450° C. and outlet temperature of 170° C. to form spherical microsphere in a co-current spray dryer unit. The spray dried catalyst was calcined at 550° C. for 4 hours to form final NTO catalyst. The physico-chemical properties of the catalyst are mentioned in Table 1.

### Example 14 (Comparative Example)

3 g of ortho-phosphoric acid, 190 g of hydrous kaolin clay, 150 g of ammonia stabilized colloidal silica and 29 g of alumina without modification were mixed to form uniform slurry and milled at 3D wet ball for 5 hours. 190 g of modified ZSM-5 from Example 2 is mixed with 300 g of DM water to form uniformed zeolite slurry. The milled slurry was mixed with zeolites slurry for 2 h to make final slurry. The slurry was spray dried at inlet temperature of 450° C. and outlet temperature of 170° C. to form spherical microsphere in a co-current spray dryer unit. The spray dried catalyst was calcined at 550° C. for 4 hours to form final product. 7.8 g Nickel nitrate is dissolved in 40 g of water and the clear green solution was impregnated in calcined dry product. The wet product was dried at 120° C. for 10 h and calcined for 550° C. for 2 h to form final catalyst. The physico-chemical properties of the catalyst are mentioned in Table 1.

TABLE 1
PHYSICO-CHEMICAL PROPERTIES OF THE CATALYST

| Property | Example 8 | Example 9 | Example 10 | Example 11 | Example 12 | Example 13 | Example 14 |
|---|---|---|---|---|---|---|---|
| Surface Area, | 180 | 178 | 170 | 174 | 172 | 185 | 160 |
| m²/g | | | | | | | |
| Pore Volume, | 0.34 | 0.3 | 0.3 | 0.31 | 0.33 | 0.38 | 0.30 |
| m³/g | | | | | | | |
| Pore size, Å | 55 | 55 | 53 | 50 | 48 | 55 | 50 |
| ABD, g/cc | 0.93 | 0.92 | 0.93 | 0.91 | 0.90 | 0.85 | 0.88 |
| Attrition | 2.7 | 2.6 | 2.7 | 3.1 | 3.4 | 16.7 | 6.8 |
| Index, % | | | | | | | |
| APS, micron | 78 | 84 | 85 | 79 | 80 | 88 | 85 |
| Total acidity, | 890 | 820 | 854 | 788 | 760 | 875 | 745 |
| mmol/g | | | | | | | |
| Chemical | | | | | | | |
| composition, | | | | | | | |
| wt % | | | | | | | |
| SiO₂ | 52.21 | 53.55 | 54.15 | 51.06 | 55.3 | 53.99 | 53.94 |
| Al₂O₃ | 34.2 | 33.1 | 32.8 | 33.4 | 33.8 | 34.8 | 32.5 |
| P₂O₅ | 8.9 | 8.75 | 8.8 | 9.2 | 8.8 | 8.78 | 8.85 |
| NiO | 2.1 | 2.05 | 2.08 | 2.02 | 1.8 | — | 2.1 |
| ZnO | 2.3 | — | — | — | — | 2.2 | 2.3 |
| Fe₂O₃ | 0.28 | 2.54 | 0.18 | 0.25 | 0.28 | 0.22 | 0.3 |
| Ga₂O₃ | — | — | 1.98 | — | — | — | — |
| Co₂O₃ | 0.0 | 0.01 | 0.01 | 2.08 | 0.02 | 0.01 | 0.01 |
| MnO₂ | — | — | — | | 1.99 | — | — |

### Example 15

Experimental verification of the functionality of the catalyst was undertaken for a hydrocarbon stream comprising light straight run naphtha. The straight run light naphtha comprises a sulfur content of approximately 100 ppm, a density of 0.68 grams per milliliter (g/ml), and a boiling point of 30 to 97° C. A fluidized bed catalytic cracking reactor was loaded with the synthesized catalyst. The reaction of the hydrocarbon stream in the fluidized bed reactor was carried out at a catalyst to oil (C/O) ratio 20, steam to hydrocarbon ratio of 12.5 (weight/weight), temperature of 650° C., and at atmospheric pressure. The effluent from the fluidized bed catalytic cracking reactor was sent to a gas-liquid separator where the gas and liquid hydrocarbon products were separated for analysis. Table-2 presents the typical properties of light straight run naphtha and Table-3 presents the product yields and light olefins selectivity from the conversion of the light straight run naphtha. For comparison purpose, the performance of commercial pentasil catalyst was tested under the same conditions in the fluidized bed catalytic cracking reactor and the results are also provided in Table 2.

TABLE 2
PROPERTIES OF LIGHT STRAIGHT RUN NAPHTHA

| Property | UoM | LSR Naphtha |
|---|---|---|
| Density at 15 Deg C. | g/cc | 0.68 |
| Total Sulphur | ppmw | 100 |
| Total Nitrogen | ppmw | 10 |
| Distillation, D-2887 | | |
| IBP | ° C. | 30 |
| 5 weight % | ° C. | 32 |
| 10 weight % | ° C. | 36 |
| 30 weight % | ° C. | 53 |
| 50 weight % | ° C. | 65 |
| 70 weight % | ° C. | 74 |
| 90 weight % | ° C. | 85 |
| 95 weight % | ° C. | 89 |
| FBP | ° C. | 96 |
| DHA analysis | | |
| N-Paraffins | weight % | 45.5 |
| Iso paraffins | weight % | 35 |
| Olefins | weight % | 0.8 |
| Naphthenes | weight % | 15.2 |
| Aromatics | weight % | 3.5 |

TABLE-3
EXPERIMENTAL RESULTS ON CATALYTIC CRACKING
OF LIGHT STRAIGHT RUN NAPHTHA

| | | Value | | | |
|---|---|---|---|---|---|
| | | Present | | | |
| | | invention | Data of | Data of | |
| | | from | Comparative | Comparative | Commercial |
| Description | UoM | Example -8 | example 13 | example 14 | catalyst |
| Product yield | | | | | |
| Dry Gas (incl H₂S, H₂, C1-C2) | weight % | 25.87 | 27.95 | 26.92 | 26.53 |
| LPG (incl C3-C4) | weight % | 47.73 | 47.3 | 42.84 | 46.89 |
| Gasoline (C5-221° C. incl BTX) | weight % | 23.4 | 23.2 | 26.34 | 23.88 |
| Heavies (221° C. and above) | weight % | 1.0 | 0.9 | 2.3 | 1.2 |
| Coke | weight % | 2.0 | 0.65 | 1.6 | 1.5 |
| Light olefin selectivity | | | | | |
| Ethylene in dry gas | weight % | 53.27 | 54.2 | 51.9 | 54.13 |
| Propylene in LPG | weight % | 49.72 | 47.5 | 44.2 | 48.29 |
| Total Butenes in LPG | weight % | 17.58 | 17.2 | 15.8 | 16.92 |
| Propylene to ethylene ratio | weight/weight | 1.72 | 1.48 | 1.36 | 1.58 |
| BTX selectivity in cracked | weight % | 59.83 | 57.6 | 55.8 | 55.42 |
| gasoline | | | | | |

A review of Table-3 indicates the total light olefins (ethylene, propylene and butylenes) yield of around 46 weight % and BTX yield of around 14 weight % for the synthesized catalyst of example-8 in comparison to 44.94 weight % and 13.23 weight % respectively for commercial pentasil catalyst. The synthesized catalyst also provides a higher Propylene/Ethylene ratio (1.72 weight/weight) in comparison to the commercial catalyst (1.58 weight/weight). It is therefore established that synthesized catalyst of the present invention products provides enhanced value in comparison to commercial catalyst for upgrading light straight run naphtha.

### Example 16

Cracking experiments were performed with full range straight run naphtha also at the same operating conditions and with the synthesized catalyst. The properties of feed and product yield pattern is provided in Tables 4 and 5 respectively.

TABLE 4
PROPERTIES OF FULL RANGE STRAIGHT RUN NAPHTHA

| | | Full range straight run |
|---|---|---|
| Property | UoM | Naphtha |
| Density at 15° C. | g/cc | 0.705 |
| Total Sulphur | ppmw | 190 |
| Total Nitrogen | ppmw | 20 |
| Distillation, D-2887 | | |
| IBP | ° C. | 32 |
| 5 weight % | ° C. | 34 |
| 10 weight % | ° C. | 38 |
| 30 weight % | ° C. | 70 |
| 50 weight % | ° C. | 104 |
| 70 weight % | ° C. | 122 |
| 90 weight % | ° C. | 136 |
| 95 weight % | ° C. | 144 |
| FBP | ° C. | 162 |
| DHA analysis | | |
| N-Paraffins | weight % | 38.6 |
| Iso paraffins | weight % | 32.2 |
| Olefins | weight % | 3.0 |
| Naphthenes | weight % | 16.0 |
| Aromatics | weight % | 10.2 |

TABLE 5
EXPERIMENTAL RESULTS ON CATALYTIC CRACKING
OF FULL RANGE STRAIGHT RUN NAPHTHA

| | | Value | | |
|---|---|---|---|---|
| | | Present | Data of | Data of |
| | | invention | Comparative | Comparative |
| Description | UoM | Example-8 | example 13 | example 14 |
| Product yield | | | | |
| Dry Gas (incl H₂S, H₂, C1-C2) | weight % | 25.64 | 27.45 | 26.33 |
| LPG (incl C3-C4) | weight % | 46.03 | 45.75 | 41.76 |
| Gasoline (C5-221° C. incl BTX) | weight % | 24.1 | 23.85 | 27.22 |
| Heavies (221° C. and above | weight % | 1.93 | 1.85 | 2.84 |
| Coke | weight % | 2.3 | 1.1 | 1.85 |
| Light olefin selectivity | | | | |
| Ethylene in dry gas | weight % | 55.72 | 55.9 | 52.7 |
| Propylene in LPG | weight % | 47.71 | 46.4 | 43.5 |
| Total Butene in LPG | weight % | 16.34 | 15.6 | 13.8 |
| Propylene to ethylene ratio | weight/weight | 1.54 | 1.38 | 1.31 |
| BTX selectivity in cracked | weight % | 40.78 | 39.1 | 37.7 |
| gasoline | | | | |

A review of Table 5 indicates the total light olefins (ethylene, propylene and butylenes) yield of around 43.77 weight % and BTX yield of around 9.83 weight % for the synthesized catalyst of example-8.

What is claimed is:

1. A process for preparing a catalyst employed for catalytic cracking of naphtha to light olefins, the process comprising:
i. mixing ortho-phosphoric acid, hydrous kaolin clay, ammonia stabilized colloidal silica and a modified alumina to form a slurry and followed by milling the slurry to form a milled slurry;
ii. preparing a modified ZSM-5 zeolite and mixing in water to form a modified zeolite slurry;
iii. mixing the milled slurry with the modified zeolite slurry to obtain a final slurry;
iv. spray drying the final slurry to obtain a spray dried catalyst; and
v. calcining the spray dried catalyst to obtain the catalyst for catalytic cracking.

2. The process as claimed in claim 1, wherein preparing the modified ZSM-5 zeolite comprises:
i. mixing a ZSM-5 zeolite with 12 to 20 weight % of a metal monohydrogen phosphate to form a zeolite mixture;
ii. adding water to the zeolite mixture to form a zeolite slurry;
iii. heating the zeolite slurry while mixing;
iv. filtering and washing the zeolite slurry to obtain a wet cake;
v. drying the wet cake; and
vi. calcining the wet cake to obtain the modified ZSM-5 zeolite.

3. The process as claimed in claim 2, wherein the ZSM-5 zeolite has a SiO2/Al2O3 ratio of 30; the metal monohydrogen phosphate has a phosphate ion loading concentration of 8 to 20 weight % and metal oxide in a range of 1 to 5 weight %.

4. The process as claimed in claim 2, wherein the zeolite slurry is heated at a temperature in a range of 70° C. to 80° C. for 3 to 5 hours; the wet cake is dried at a temperature in a range of 120° C. to 150° C. for 10 to 18 hours and calcined at a temperature in a range of 700° C. to 750° C. for 3 to 5 hours.

5. The process as claimed in claim 2, wherein the metal monohydrogen phosphate is prepared by a process comprising:
i. mixing a metal precursor in water and adding orthophosphoric acid in a mol ratio of 1:1 to form a solution;
ii. adding an ammonia solution to the solution to reach a pH above 10 and to form a precipitate;
iii. separating the precipitate through filtering;
iv. washing the precipitate to obtain a washed product; and
v. drying the washed product to obtain the metal monohydrogen phosphate.

6. The process as claimed in claim 2, wherein the metal monohydrogen phosphate is selected from the group consisting of zinc monohydrogen phosphate, iron monohydrogen phosphate, gallium monohydrogen phosphate, cobalt monohydrogen phosphate, and manganese monohydrogen phosphate.

7. The process as claimed in claim 5, wherein the metal precursor is selected from the group consisting of zinc nitrate hexahydrate, gallium nitrate hydrate, iron nitrate hexahydrate, cobalt nitrate hexahydrate and manganese nitrate hexahydrate.

8. The process as claimed in claim 5, wherein the precipitate is washed with water at a temperature in a range of 70-80° C. to bring the pH in the range of 6-7; the washed product is dried at a temperature in a range of 120° C. to 150° C. for 5 to 10 hours.

9. The process as claimed in claim 1, wherein the modified alumina is prepared by mixing alumina with nickel nitrate hexahydrate in water to form a mixture; followed by drying the mixture to obtain a dried product; and calcining the dried product to obtain the modified alumina.

10. The process as claimed in claim 1, wherein the milled slurry is mixed with modified zeolite slurry for 2 to 5 hours to make the final slurry; the final slurry is spray dried in a co-current spray drying unit having an inlet temperature of 370° C. to 450° C. and an outlet temperature of 170° C. to 200° C. to obtain the spray dried catalyst; the spray dried catalyst is calcined at a temperature in a range of 550° C. to 600° C. for 4 to 6 hours; wherein the catalyst is formed in a spherical microsphere shape.

11. A catalyst employed for catalytic cracking of naphtha to light olefins, the catalyst comprising:
i. a modified ZSM-5 zeolite in a range of 40 to 60 weight % of the catalyst; and
ii. a modified alumina in a range of 1 to 20 weight % of the catalyst;
wherein the modified ZSM-5 zeolite has a matrix framework structure and a surface, wherein the modified ZSM-5 zeolite comprises a ZSM-5 zeolite having a SiO2/Al2O3 ratio of 30, wherein the modified ZSM-5 zeolite is embedded in the matrix framework structure with a phosphate of a metal selected from the group consisting of zinc, iron, gallium, cobalt, manganese and a combination thereof, and wherein the modified alumina is in contact with the surface of the modified ZSM-5 zeolite.

12. The catalyst as claimed in claim 11, wherein the catalyst has a chemical composition comprising:
i. SiO2 in 50 to 60 weight % of the catalyst;
ii. Al2O3 in 30 to 40 weight % of the catalyst;
iii. P2O5 in 6 to 12 weight % of the catalyst;
iv. NiO in 1 to 3 weight % of the catalyst; and
v. and a metal oxide comprising ZnO, Fe2O3, Ga2O3, Co2O3, MnO2, or a combination thereof.

13. The catalyst as claimed in claim 12, wherein ZnO is in a range of 1 to 2.5 weight % of the catalyst; Fe2O3 is in a range of 0.18 to 2.54 weight % of the catalyst; Ga2O3 is in a range of 0.5 to 1.98 weight % of the catalyst; Co2O3 is in a range of 0.01 to 2.08 weight % of the catalyst; MnO2 is in a range of 0.5 to 1.99 weight % of the catalyst.

14. The catalyst as claimed in claim 11, wherein the catalyst is a spherical microsphere having a surface area in a range of 160 to 180 m2/g; has a pore volume in a range of 0.3 to 0.34 m3/g; has a pore size in a range of 48 to 55 Å; has an ABD in a range of 0.90 to 0.93 g/cc; has an attrition index in a range of 2.6 to 3.4%; has an average particle size in a range of 78 to 85 micron; and has a total acidity of 760 to 890 mmol/g.

15. A process for catalytic cracking of naphtha to light olefins employing a catalyst, the process comprising:
i. contacting a hydrocarbon stream comprising a fresh naphtha feed and a recycle liquid product stream with the catalyst and steam in a riser of a fluidized bed reactor to obtain a cracked effluent comprising gaseous products, liquid products, water and a spent catalyst;
ii. separating the spent catalyst from the cracked effluent in a gas solid separation system to obtain a reactor effluent, wherein the gas solid separation system comprises a reactor and a cyclone separator housed in the reactor, and sending the reactor effluent to a gas-liquid separation section for separating a gaseous product stream comprising C1-C4 hydrocarbons from a liquid product stream comprising benzene, toluene, and xylene (BTX);
iii. sending the spent catalyst to a stripper to remove strippable hydrocarbons from the spent catalyst;
iv. passing the gaseous product stream to a gas separator unit to remove a stream enriched in hydrogen and methane from the gaseous product stream for generating an enhanced gas stream comprising an increased concentration of C2-C4 hydrocarbons and subsequently separating lighter olefins comprising ethylene, propylene and butene from the C2-C4 hydrocarbons;
v. extracting BTX from the liquid product stream in a separation column to obtain a recycle liquid product stream, and sending the recycle liquid product stream devoid of BTX to the riser for cracking to extinction;
vi. partially drawing the spent catalyst from the stripper to a coke concentrator wherein the spent catalyst is contacted with an external feed comprising heavy hydrocarbons having a boiling point of above 340° C., or a biocrude or a combination thereof to obtain a cracked product and coke, wherein the coke gets deposited on the spent catalyst to obtain a coke enriched spent catalyst;
vii. routing the cracked product from coke concentrator to the reactor; and
viii. sending the coke enriched spent catalyst from the coke concentrator and the spent catalyst directly from the stripper to a regenerator wherein the coke deposited on the spent catalyst burns with oxygen containing gases to obtain a flue gas and a regenerated catalyst;
ix. circulating the regenerated catalyst from the regenerator to the riser for cracking the hydrocarbon stream comprising the fresh naphtha feed and the recycle liquid product stream, wherein the catalyst, the catalyst comprises a modified ZSM-5 zeolite in a range of 40 to 60 weight % of the catalyst; and a modified alumina in a range of 1 to 20 weight % of the catalyst,
wherein the catalyst comprises a modified ZSM-5 zeolite in a range of 40 to 60 weight % of the catalyst; and a modified alumina in a range of 1 to 20 weight % of the catalyst, wherein the modified ZSM-5 zeolite has a matrix framework structure and a surface, wherein the modified ZSM-5 zeolite comprises a ZSM-5 zeolite having a SiO2/Al2O3 ratio of 30, wherein the modified ZSM-5 zeolite is embedded in the matrix framework structure with a phosphate of a metal selected from the group consisting of zinc, iron, gallium, cobalt, manganese and a combination thereof; and wherein the modified alumina is in contact with the surface of the modified ZSM-5 zeolite.

16. The process as claimed in claim 15, wherein the fresh naphtha feed is virgin or straight run naphtha streams, or cracked naphtha streams, wherein the fresh naphtha feed has a sulfur content in a range of 10 to 500 ppm, a density in a range of 0.65 to 0.75 g/ml, and a boiling point in a range of 30 to 210° C.

17. The process as claimed in claim 15, wherein the hydrocarbon stream in the fluidized bed reactor is contacted with the catalyst at a catalyst to hydrocarbon weight ratio of 18 to 25; the steam to hydrocarbon weight ratio of 10 to 50 and at a temperature in a range of 600 to 700° C.
